(19) United States
(12) Patent Application Publication
(10) Pub. No.: US 2015/0322789 A1
(43) Pub. Date: Nov. 12, 2015

(54) REAL-TIME MONITORING OF GAS TURBINE LIFE

(71) Applicant: General Electric Company, Schenectady, NY (US)

(72) Inventors: Achalesh Kumar Pandey, Greenville, SC (US); Khan Mohamed Khirullah Genghis Khan, Niskayuna, NY (US); Venkatesh Kattigari Madyastha, Bangalore (IN); Niranjan Gokuldas Pai, Niskayuna, NY (US); Romano Patrick, Marietta, GA (US); Johan Michael Reimann, Niskayuna, NY (US); Felipe Antonio Chegury Viana, Niskayuna, NY (US)

(73) Assignee: General Electric Company, Schenectady, NY (US)

(21) Appl. No.: 14/270,588

(22) Filed: May 6, 2014

(51) Int. Cl. F01B 25/00; G01M 15/14

(52) U.S. Cl. CPC F01B 25/00; G01M 15/14

(57) ABSTRACT

A system, method and computer-readable medium for monitoring a life of a gas turbine component is disclosed. A numerical model of the gas turbine component is created and parameter measurements are obtained in real-time for at least a portion of the gas turbine component. The parameter measurements are fused with a subset of the numerical model corresponding to the portion of the gas turbine component to obtain a subset of a fused parameter model corresponding to the portion of the gas turbine component. The subset of the fused parameter model is expanded to obtain the fused parameter model that corresponds to at least a location outside of the portion of the gas turbine component. The life of the gas turbine component is monitored using the fused temperature model.

### BACKGROUND OF THE INVENTION

The present invention relates to a system and method for determining life expectancy of a gas turbine component, and more specifically, to determining life expectancy of a gas turbine component in real-time using thermal measurements obtained in-situ.

Gas turbines used in power generation include a number of moving and stationary parts or components that have limited useful life and consume life during operation of the gas turbine. Turbine blades, for example, develop stresses due to their rotation about a rotary shaft and exposure to hot gases flowing around them. In order to maintain the gas turbines, the moving parts are often monitored to determine their health and/or to estimate a component's life span. Currently, a life or health of a component of a gas turbine is estimated by running using numerical models of the gas turbine part. This methodology provides average life and worst case life at a specific location of the component. More complete analysis may only be performed once the gas turbine is offline and direct access to the component is available.

### BRIEF DESCRIPTION OF THE INVENTION

According to one aspect of the present invention, a method of monitoring a life of a gas turbine component includes: estimating, using a processor, a numerical model of a parameter at the gas turbine component; obtaining measurements of the parameter in real-time for a portion of the gas turbine component; fusing the parameter measurements and a subset of the numerical model corresponding to the portion of the gas turbine component to obtain a subset of a fused parameter model corresponding to the portion of the gas turbine component; expanding the subset of the fused parameter model obtain the fused parameter model that corresponds to at least a location outside of the portion of the gas turbine component; and monitoring the life of the gas turbine component using the fused parameter model.

According to another aspect of the present invention, a system for monitoring a life of a gas turbine component, including: a sensor configured to measure a parameter in real-time at a portion of the gas turbine component; and a processor configured to: create a numerical model of the parameter for the gas turbine component, fuse the real-time parameter measurements to a subset of the numerical model corresponding to the portion of the gas turbine component to obtain a subset of a fused parameter model for the portion of the gas turbine component, expand the subset of the fused parameter model for the portion of the gas turbine component to obtain the fused parameter model for a location outside of the portion of the gas turbine component, and monitor the life of the gas turbine component using the fused parameter model.

According to another aspect of the present invention, a non-transitory computer-readable medium including instructions stored thereon that when accessed by a processor, enable the processor to perform a method of monitoring a life of a gas turbine component, the method including: estimating a numerical model of a parameter at the gas turbine component; obtaining measurements of the parameter in real-time for a portion of the gas turbine component; fusing the parameter measurements and a subset of the numerical model corresponding to the portion of the gas turbine component to obtain a subset of a fused parameter model corresponding to the portion of the gas turbine component; expanding the subset of the fused parameter model to obtain the fused parameter model that corresponds to at least a location outside of the portion of the gas turbine component; and monitoring the life of the gas turbine component using the fused parameter model.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWING

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 shows a system for monitoring a life span or health of a gas turbine component such as a turbine blade;

FIG. 2 shows an illustrative three-dimensional model of a turbine blade that can be used to determine mechanical and thermal loads on the turbine blade;

FIG. 3 shows a graphical representation of dimensionality reduction through singular value decomposition of a matrix representation of the three-dimensional model;

FIG. 4 shows illustrative temperature measurements obtained from an infrared camera for the exemplary turbine blade.

FIG. 5 illustrates fusing of temperature measurements from the infrared camera with a reduced order model to obtain a fused model;

FIG. 6 illustrates a graphical representation of expanding the fused model obtained in FIG. 5 over the turbine blade; and

FIG. 7 shows a flowchart illustrating an exemplary method of the present disclosure for determining a life span of a turbine blade or turbine component in one embodiment.

### DETAILED DESCRIPTION OF THE INVENTION

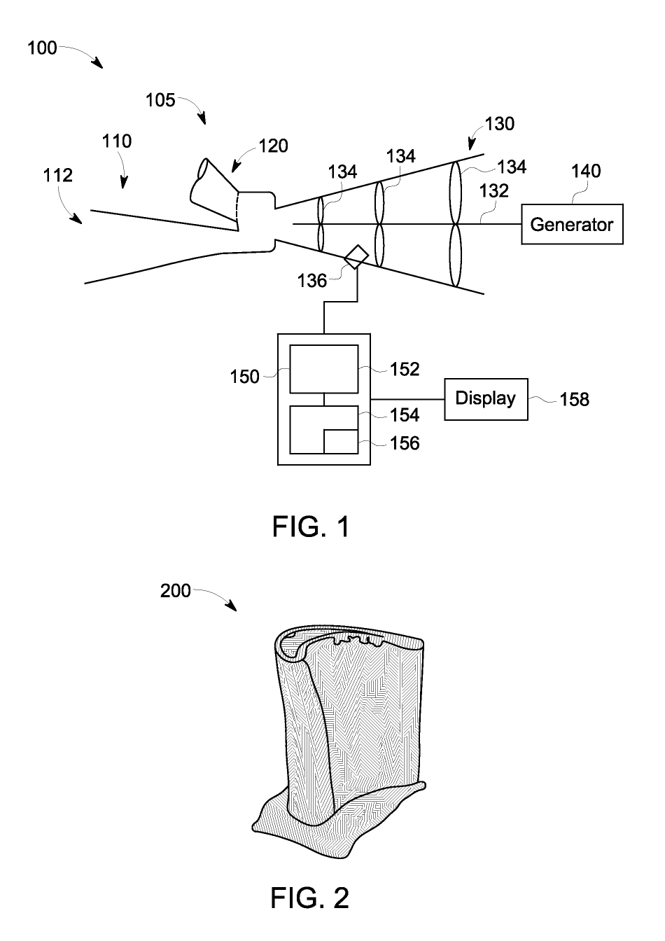

FIG. 1 shows a system 100 suitable for monitoring a life span or health of a gas turbine component such as a turbine blade 134. In alternate embodiments, the component can be a gas turbine bucket, a nozzle, a shroud, a compressor blade, etc. The system 100 includes a gas turbine 105 including a compressor stage 110, a combustor 120 and a turbine stage 130. Air is taken into the gas turbine 105 via an air inlet 112 of the compressor stage 110 and is compressed in the compressor stage 110. In the combustor 120, the compressed air from the compressor stage 110 is mixed with fuel and ignited to form a working gas that is exhausted through the turbine stage 130. The turbine stage 130 includes a rotary shaft 132 that includes a plurality of turbine blades 134 extending radially from the rotary shaft 132. The working gas passes over the turbine blades 134 to impart a rotation to the rotary shaft 132. The rotary shaft 132 can be coupled to a generator 140, thereby causing the generator 140 to generate electricity. The turbine blades 134 of the turbine stage 130 often experience mechanical and thermal loads during the course of operation of the gas turbine 105, resulting in limited life span of the turbine blades 134 and required maintenance stops.

The system 100 further includes a measurement device that obtains data related to the mechanical and thermal loads on the gas turbine component. In an illustrative embodiment, the measurement device is an infrared camera 136 that captures thermal data of the turbine blade 134. While the measurement device is described herein as an infrared camera 136, the measurement device can measure any suitable parameter such as mechanical loads (i.e., stresses, strains, etc.) in alternate embodiments. The infrared camera 136 is directed at a location in the turbine stage 130 through which the turbine blades 134 pass during rotation of the rotary shaft 132. The infrared camera 136 can be synchronized with a rotation of the rotary shaft 132 so that that infrared camera 136 takes an image of the location once per revolution of the rotary shaft 132. Therefore, a turbine blade 134 that is imaged by the infrared camera 136 at the location is imaged again once it has completed its revolution about the rotary shaft 132. In alternative embodiments, the infrared camera 136 can be synchronized with the rotation of the rotary shaft 132 so that the infrared camera 136 takes images multiple times during a single revolution, thereby obtaining thermal images of a plurality of turbine blades 134. A program can then be used to separate thermal images according to their corresponding turbine blades 134. The thermal image obtained at the infrared camera 136 provides thermal data, such as thermal gradients, temperature variations, etc., at the surface of the turbine blade 134. The thermal data can be used to determine one or more stresses or strains at the turbine blade 134, which can be used to estimate life consumption from fatigue, creep, oxidation, etc. However, the field-of-view of the infrared camera 136 generally captures or images only a portion of the surface of the turbine blade 134.

The system 100 further includes a control unit 150 coupled to the gas turbine 105. The control unit 150 receives the thermal images from the infrared camera 136 and use the thermal images to estimate a lifespan or health of the turbine blade 134 imaged by the infrared camera 136. The control unit 150 includes a processor 152 coupled to a memory storage device 154. The memory storage device 154 includes programs 156 that can be accessed by the processor 152. When accessed, the programs 156 enable the processor 152 to perform the various methods disclosed herein for estimating a life span or health of a gas turbine component, such as the turbine blade 134 of the turbine stage 130. In one embodiment, the processor 152 fuses the obtained thermal images from infrared camera 136 with a numerical model of the turbine blades 134 to obtain a fused model and performs calculations described herein using the fused model to determine temperatures, stresses and strains at one or more locations of the turbine blade 134, such as locations that are outside of the field-of-view of the infrared camera 136. The three-dimensional model, thermal data, determined stresses, etc. may be sent to a display 158 for review by a user.

FIG. 2 shows an illustrative numerical model 200 of a turbine blade 134 that can be used to determine stresses on the turbine blade 134. The numerical model 200 is a three-dimensional model and includes a plurality of nodes defining a mesh of points at discrete locations of the turbine blade 134. Each mesh point can be used to represent a parameter at the selected mesh point location, wherein the parameter can be temperature, temperature gradient, mechanical stress and strain, thermal stress and strain, or various life consumption parameters related to failure modes such as creep, fatigue, oxidation, etc. A reduced order model of the turbine blade can be built by running finite element simulations at different input configurations, such as different operating conditions of the gas turbine 100. The input configurations are recorded in a matrix X_{p×d}, wherein p represents a number of data points and d represents a number of input variables. The numerical model 200 is used to represent three dimensional fields for a selected parameter (i.e., stress, strain, temperature) over the turbine blade 134. For example, a matrix T_{p×n} represents the temperature field at the turbine blade 134, wherein n represents a number of degrees of freedom in the finite element model.

Singular value decomposition can then be used to reduce the n-dimensional field of the numerical model 200 to its c most significant elements. In the illustrative example using temperature as the parameter, a temperature matrix T_{p×n} can be rewritten as:

T_{p×n}≅U_{p×c}×S_{c×c}×B_{c×n} Eq. (1)

where the U matrix describes how temperature changes at the numerical model 200 as a function of various input variables such as blade rotation, operating temperature, etc., the S matrix provides a weight or quantitative measure at each node, and the B matrix describes a correlation between temperatures over the turbine blade and provides a coordinate system that describes a temperature field in the singular value decomposition space. In Eq. (1), the index c is generally much less than n (c<<n). The same process of singular value decomposition can be applied to stress and strain field matrices.

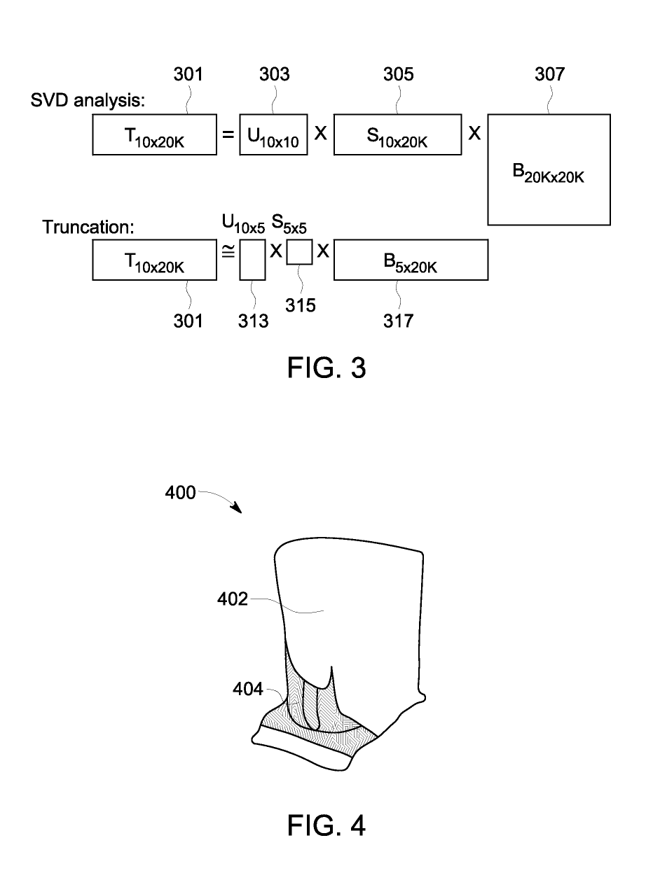

A reduced order model is created by approximating the U matrix of Eq. (1) with a suitable approximation technique, such as a Gaussian process, radial basis functions, or any other suitable method. In various embodiments, the temperature of the reduced order model can be a thermal barrier coating surface temperature, a metal temperature, surface strain or stress, etc. FIG. 3 shows a graphical representation of order reduction on a singular value decomposition of the temperature matrix. For illustrative purposes only, temperature matrix T (301) of the turbine blade is represented as a 10 by 20,000 matrix (which means that the finite element model has 20,000 degrees of freedom to describe the temperature field and it has been exercised at 10 different input conditions), the U matrix (303) is represented as a 10 by 10 matrix, the S matrix (305) is represented as a 10 by 20,000 matrix and the B matrix (307) is represented as a 20,000 by 20,000 matrix. This is also represented by Eq. (2):

T_{10×20K}=U_{10×10}×S_{10×20K}×B_{20K×20K} Eq. (2)

Upon reducing the order of the T matrix, the truncated U matrix (313) is represented as a 10 by 5 matrix, the truncated S matrix (315) is represented as a 5 by 5 matrix and the truncated B matrix (317) is represented as a 5 by 20,000 matrix. The reduced order model is also represented by Eq. (3):

T_{10×20K}=U_{10×5}×S_{5×5}×B_{5×20K} Eq. (3)

The steps of producing the temperature model, performing the singular value decomposition and reduction of order are performed prior to obtaining data measurements. The resulting reduced-order model can then be fused with measurement data such as thermal image data to obtain temperature, stresses, and strains at the turbine blade 134 or other data related to life consumption of the turbine blade 134. Additionally, using the analytical models described herein with respect to various operating parameters, it is possible to estimate life in three-dimensional space.

FIG. 4 shows illustrative temperature measurements obtained from an infrared camera for the exemplary turbine blade. The temperature measurements are shown superimposed on the reduced order model 400 of the turbine blade. For every node of the reduced order model, there is a corresponding temperature measurement. The temperature measurements corresponding to nodes of the reduced order model that are in the field-of-view 404 of the infrared camera 136 and can be used to calibrate temperature values for those nodes. The corresponding temperature measurements can also be fused with the temperature values for the nodes in the field-of-view of the infrared camera 136 to obtained fused temperature values. These fused temperature values can be used to obtain temperature values at node locations 402 outside of the field-of-view 404 of the infrared camera 136.

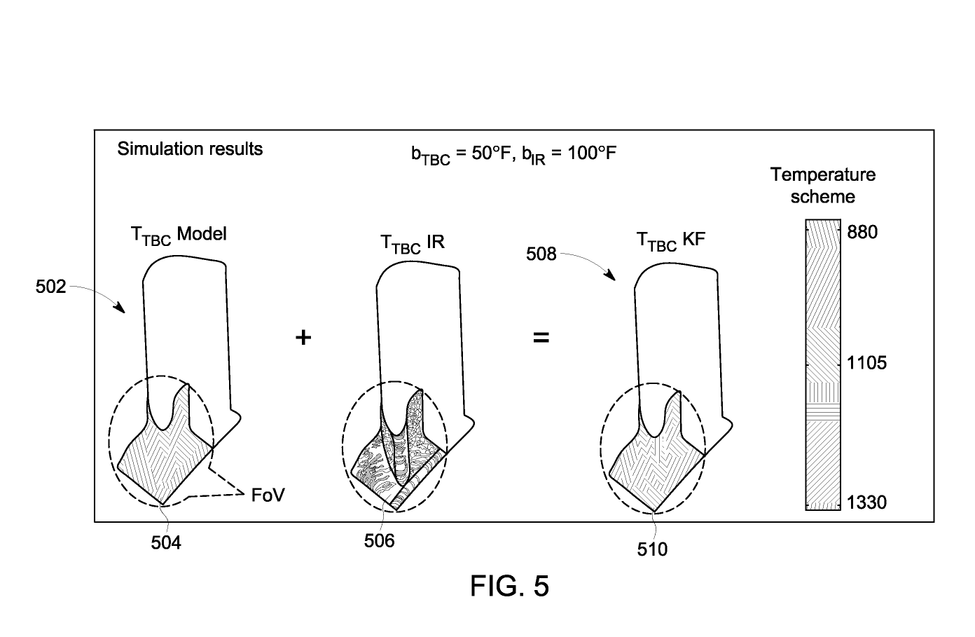

FIG. 5 illustrates fusing of temperature measurements from the infrared camera 136 with the reduced order model to obtain a fused model. The temperature values of the reduced order model 502 are shown for a portion of the gas turbine blade that is in the field-of view 504 of the infrared camera 136. The measured temperatures 506 in the field-of-view of the infrared camera 136 are also shown. The fused model 508 is a fusion of the field-of view 504 portion of the reduced order model 502 and the measured parameter values 506. In various embodiments, fusing the measurement data 506 with the reduced order model parameter values 594 may employ a Kalman filter.

The Kalman filter may estimate temperature values for the fused model 508 using measured temperature values 506 along with sensor biases and uncertainties as well as temperature values of the reduced order model 502 along with their biases and uncertainties. For temperature measurements, the bias of the infrared camera 136 generally results from an uncertainty due to heat transfer analysis, an uncertainty due to emissivity changes and an uncertainty due to reflection calculations.

In matrix notation, the temperature measurements obtained by the infrared camera 136 can be represented by a matrix t, which has a dimension less than the matrix T of the reduced order model. In one example, matrix t has dimensions of 1 by 1500, whereas the T matrix has dimensions of 10 by 20,000. Singular value decomposition can be performed on matrix t to obtain Eq. (4):

t_{1×1500}=u_{1×5}×S_{5×5}×B*_{5×1500} Eq. (4)

where the B* matrix represents only the elements of the B matrix that correspond to the nodes that are in the field of view of the infrared camera 136. Since the S matrix and the B* matrix are numerically determined, they can be used to determine the u matrix via Eq. (5):

u_{1×5}=t(SB*)^{T}(SB*(SB*)^{T})⁻¹ Eq. (5)

The determined u matrix can then be used to obtain temperature estimates over various portions of the turbine blade model outside of the field of view of the infrared camera 136. Eq. (6) shows the determined u matrix applied to the known S and B matrices to obtain a T matrix of the three-dimensional model:

t_{1×20K}=u_{1×5}×S_{5×5}×B_{5×20K} Eq. (6)

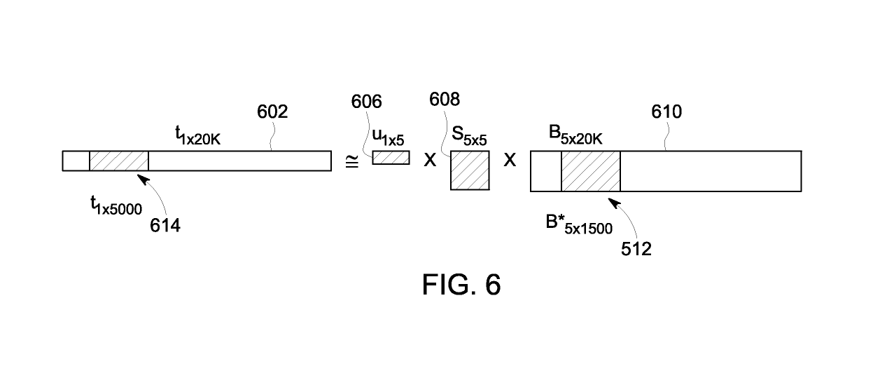

FIG. 6 illustrates expanding the fused model obtained in FIG. 5 to cover at least a portion of the component that is outside of the field-of-view of the infrared camera. The expansion obtains a temperature matrix T. The matrix elements of Eq. (4) above are represented by the darkened boxes 614, 606, 608 and 612. The matrix elements of Eq. (6) are represented by boxes 602, 606, 608 and 612. The thermal data is represented at the t matrix (box 614). The matrices represented by boxes 608 and 612 are determined from numerical simulations. Thus, the u1×5 matrix (box 606) can be determined from the thermal data (box 614) and the S matrix (box 608) and B* matrix (box 612). Then, the u matrix (box 606), S matrix (box 608) and B matrix (box 610) are used to determine the t1×20K matrix (box 602).

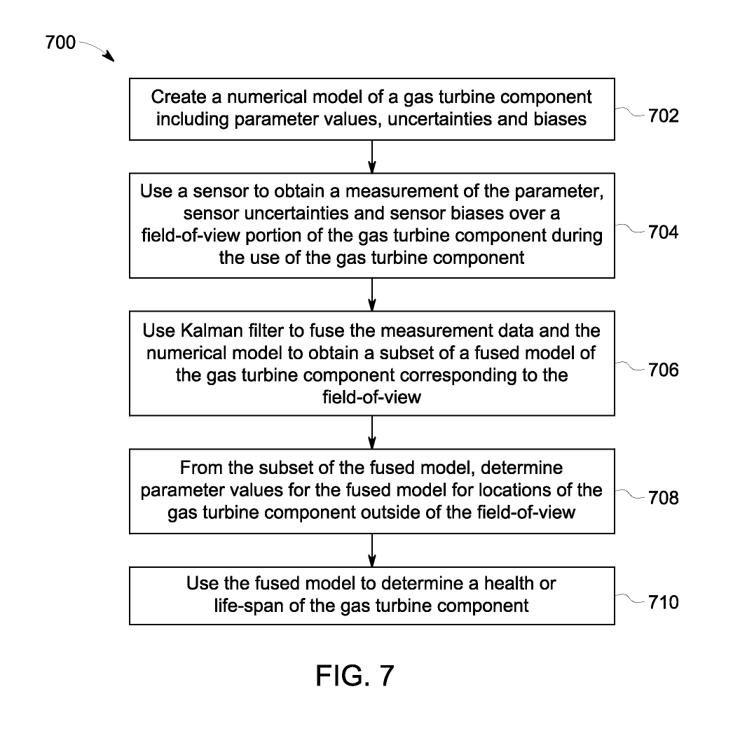

FIG. 7 shows a flowchart 700 illustrating an exemplary method of the present disclosure for determining a life span of a turbine blade or turbine component in one embodiment. In block 702, a numerical model of a gas turbine component is created. The numerical model can include a reduced order model of the turbine blade obtained via singular value decomposition and truncation processes and can include various numerical uncertainties and biases associated with these processes. In block 704, a sensor is used to obtain a measurement of the parameter over a field-of-view portion of the gas turbine component during the use of the gas turbine component. The obtained measurements of the parameter, sensor uncertainties and sensor biases are sent to a processor.

In block 706, a Kalman filter is used to fuse the measurement data from the sensor with a portion of the numerical model within the field-of-view of the sensor to obtain a fused model. The parameter values of the fused model are for the portion of the component that is within the field-of-view of the sensor. The Kalman filter obtains the fused model using the parameter measurements, numerical parameter values, the sensor biases and uncertainties and the model biases and uncertainties. In block 708, the fused model is expanded to determine parameter values for the fused model at locations of the component that are outside of the field-of-view of the sensor. In bock 710, the expanded fused model for the component then used to determine a health or life-span of the component.

Thus, the methods disclosed herein can be used to estimate a life span of a gas turbine component using a three-dimensional model of the gas turbine component and obtained thermal data. The model of thermal data over the surface of the turbine blade 134 can be used to determine a model of stresses, for example, at the turbine blade 134. The stress model can then be monitored while the gas turbine component is in use, and the life span of the gas turbine component can be determined while the gas turbine component is in use. Therefore, it is possible to schedule suitable maintenance times for the gas turbine.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method of monitoring a life of a gas turbine component, comprising:
estimating, using a processor, a numerical model of a parameter at the gas turbine component;
obtaining measurements of the parameter in real-time for a portion of the gas turbine component;
fusing the parameter measurements and a subset of the numerical model corresponding to the portion of the gas turbine component to obtain a subset of a fused parameter model corresponding to the portion of the gas turbine component;
expanding the subset of the fused parameter model obtain the fused parameter model that corresponds to at least a location outside of the portion of the gas turbine component; and
monitoring the life of the gas turbine component using the fused parameter model.

2. The method of claim 1, wherein obtaining the real-time parameter measurements further comprises obtaining at least one of: (i) a temperature measurement; (ii) a stress measurement; (iii) a strain measurement; and (iv) a measurement of a parameter related to a mechanical load on the component.

3. The method of claim 1, wherein expanding the subset of the fused parameter model further comprises using singular value decomposition of the numerical model.

4. The method of claim 1, wherein the numerical model of the parameter further comprises a three-dimensional model of the parameter at the gas-turbine component.

5. The method of claim 4, wherein the numerical model of the parameter is a reduced order model.

6. The method of claim 1, further comprising using the fused temperature model to determine a life consumption parameter at the gas turbine component and monitoring the life of the gas turbine component using the determined life consumption parameter.

7. The method of claim 1, wherein the gas turbine component further comprises at least one of: a gas turbine bucket; a nozzle; a shroud; and a compressor blade.

8. A system for monitoring a life of a gas turbine component, comprising:
a sensor configured to measure a parameter in real-time at a portion of the gas turbine component; and
a processor configured to:
create a numerical model of the parameter for the gas turbine component,
fuse the real-time parameter measurements to a subset of the numerical model corresponding to the portion of the gas turbine component to obtain a subset of a fused parameter model for the portion of the gas turbine component,
expand the subset of the fused parameter model for the portion of the gas turbine component to obtain the fused parameter model for a location outside of the portion of the gas turbine component, and
monitor the life of the gas turbine component using the fused parameter model.

9. The system of claim 8, wherein the sensor further comprises a sensor selected from the group consisting of: (i) a temperature sensor; (ii) an infrared camera; (iii) a sensors for measuring stress; (iv) a sensors for measuring strain; and (v) a sensor for measuring a parameter related to a mechanical load on the component.

10. The system of claim 8, wherein the processor is further configured to expand the subset of the fused parameter model to obtain the fused parameter model of the parameter at a location outside of the portion of the gas turbine using a singular value decomposition of the numerical model.

11. The system of claim 8, wherein the numerical model further comprises a three-dimensional model of the gas turbine component.

12. The system of claim 8, wherein the numerical model is a reduced order model.

13. The system of claim 8, wherein the processor is further configured to determine a life consumption parameter at the gas turbine component from the fused temperature model and monitor the life of the gas turbine component using the determined damage parameter.

14. The system of claim 8, wherein the gas turbine component further comprises at least one of: a gas turbine bucket; a nozzle; a shroud; and a compressor blade.

15. A non-transitory computer-readable medium including instructions stored thereon that when accessed by a processor, enable the processor to perform a method of monitoring a life of a gas turbine component, the method comprising:
estimating a numerical model of a parameter at the gas turbine component;
obtaining measurements of the parameter in real-time for a portion of the gas turbine component;
fusing the parameter measurements and a subset of the numerical model corresponding to the portion of the gas turbine component to obtain a subset of a fused parameter model corresponding to the portion of the gas turbine component;
expanding the subset of the fused parameter model to obtain the fused parameter model that corresponds to at least a location outside of the portion of the gas turbine component; and
monitoring the life of the gas turbine component using the fused parameter model.

16. The non-transitory computer-readable medium of claim 15, wherein the method further comprises obtaining the real-time temperature measurements from a group consisting of: (i) a temperature measurement; (ii) a stress measurement; (iii) a strain measurement; and (iv) a measurement of a parameter related to a mechanical load on the component.

17. The non-transitory computer-readable medium of claim 15, wherein the method further comprises expanding the subset of the fused parameter model by using singular value decomposition of the numerical model.

18. The non-transitory computer-readable medium of claim 15, wherein the numerical model further comprises a three-dimensional model.

19. The non-transitory computer-readable medium of claim 15, wherein the numerical model is a reduced order model.

20. The non-transitory computer-readable medium of claim 15, wherein the method further comprises using the fused temperature model to determine a life consumption parameter at the gas turbine part and monitoring the life of the gas turbine part using the determined life consumption parameter.
